(19) United States
(12) Patent Application Publication
(10) Pub. No.: US 2024/0095570 A1
(43) Pub. Date: Mar. 21, 2024

(54) SYSTEM AND METHOD FOR QUANTUM CIRCUIT DESIGN FOR COGNITIVE INTERFERENCE EFFECTS

(71) Applicant: IonQ, Inc., College Park, MD (US)

(72) Inventors: Dominic WIDDOWS, Seattle, WA (US); Jyoti RANI, Berkeley, CA (US); Daiwei ZHU, College Park, MD (US)

(21) Appl. No.: 18/469,104

(22) Filed: Sep. 18, 2023

Related U.S. Application Data
(60) Provisional application No. 63/376,274, filed on Sep. 19, 2022.

(51) Int. Cl. G06N 10/40; G06N 10/20; G06N 10/60

(52) U.S. Cl. CPC G06N 10/40; G06N 10/20; G06N 10/60

(57) ABSTRACT

A system and method is provided for designing and configuring a quantum circuit that models known “interference effects” between mutually exclusive events whose outcome is not yet known. An exemplary method includes applying a laser to an ion trap to set a probability of a single event by rotating at least one qubit; configuring the quantum circuit to connect a plurality of events, such that an outcome of the single event dictates an output of a subsequent event to be more or less likely to occur; configuring the quantum circuit to entangle the respective plurality of events such that a plurality of states representing different potential events interfere with one another, including an interference between incompatible outcomes of at least two of the plurality of events; and configuring the quantum circuit to measures the respective outcomes to model a result when the quantum computer determines an outcome of an event, such that possible outcomes of other events are removed.

### CROSS REFERENCE TO RELATED APPLICATIONS

The current application claims priority to U.S. Patent Provisional Application No. 63/376,274, filed Sep. 19, 2022, the entire contents of which are hereby incorporated by reference.

### TECHNICAL FIELD

Aspects of the present disclosure relate generally to systems and methods for use in the implementation and/or operation of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of systems and methods for the designing and configuration a quantum circuit that accurately models scenarios in cognitive science that are known to violate assumptions from classical probability.

In an exemplary aspect, the system and method described herein is configured to design a quantum circuit that models known “interference effects” between mutually exclusive events whose outcome is not yet known, in such a way that an event that depends on these events is judged to be more or less likely than the classical law of total probability would allow. In an exemplary aspect, the circuit design has four components: (1) a configuration to “set” the probability of a particular event (e.g., by rotating a coordinate frame to fix an angle between two pairs of axes, (2) a configuration to connect events saying that the outcome of a particular event may make an output of a subsequent event more or less likely, (3) a configuration to “entangle” events so that states representing different potential events can interfere with one another, including interference between incompatible outcomes, and (4) a configuration that “measures” events to model what happens when the system learns the outcome of one of the hitherto unknown events and to remove the possibility of other outcomes. The combination of such components according to the disclosed system and method accurately models disjunction interference effects from cognitive science.

According to an exemplary aspect a method is provided for configuring a quantum circuit having a plurality of qubits that model cognitive interference effects. In this aspect, the method includes applying a laser to an ion trap including a plurality of ions to set a probability of a single event by rotating at least one qubit of the plurality of qubits to fix a relative angle of the at least one qubit; configuring the quantum circuit to connect a plurality of events, including the single event, such that an outcome of the single event dictates an output of a subsequent event of the plurality of events to be more or less likely to occur; configuring the quantum circuit to entangle the respective plurality of events such that a plurality of states representing different potential events interfere with one another, including an interference between incompatible outcomes of at least two of the plurality of events; and configuring the quantum circuit to measures the respective outcomes of the plurality of events to model a result when the quantum computer determines an outcome of at least one event of the plurality of events, such that possible outcomes of other events of the plurality of events are removed.

According to another exemplary aspect, a system is provided for configuring a quantum circuit having a plurality of qubits that model cognitive interference effects. In this aspect, the system includes an ion trap configured to trap a plurality of ions; an optical and trap controller configured to apply a laser to the ion trap to set a probability of a single event by rotating at least one qubit of the plurality of qubits to fix a relative angle of the at least one qubit; and a controller configured to configure the quantum circuit to connect a plurality of events, including the single event, such that an outcome of the single event dictates an output of a subsequent event of the plurality of events to be more or less likely to occur, configure the quantum circuit to entangle the respective plurality of events such that a plurality of states representing different potential events interfere with one another, including an interference between incompatible outcomes of at least two of the plurality of events, and configure the quantum circuit to measures the respective outcomes of the plurality of events to model a result when the quantum computer determines an outcome of at least one event of the plurality of events, such that possible outcomes of other events of the plurality of events are removed.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an exemplary of an X-rotation applied to set an output probability in accordance with aspects of this disclosure.

FIG. 5 illustrates an implementation of a basic combination of changing the probability of second event based on an occurrence of a first event in accordance with aspects of this disclosure.

FIG. 6 illustrates a classical Bayesian network connecting two events in accordance with aspects of this disclosure.

FIG. 7 illustrates a quantum circuit in accordance with aspects of this disclosure.

FIG. 8 illustrates a quantum circuit configured as a conditional probability with interference circuit in accordance with aspects of this disclosure.

FIG. 9 illustrates how the circuit of FIG. 8 is configured to behave with the numbers filled in from an example of a “Prisoner's Dilemma” problem in accordance with aspects of this disclosure.

FIG. 10 illustrates a quantum circuit having a configuration modeled without mid-circuit measurement using swap gates and ancilla qubits in accordance with aspects of this disclosure.

FIG. 11 illustrates a quantum circuit in accordance with aspects of this disclosure.

FIGS. 12A-12C illustrate quantum circuits configured to process question vectors order effects in accordance with aspects of this disclosure.

FIG. 13 illustrates a method for configuring a quantum circuit having a plurality of qubits that model cognitive interference effects in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

In general, many cognitive psychology experiments have shown that human decision-making violates certain assumptions made in classical probability. Mathematical models based on quantum probability can fit the observed psychological data more accurately. These quantum approaches work by assuming that incompatible outcomes of an event interfere with one another unless the outcome is known, and this affects the probability of subsequent events conditioned on the event whose outcome is unknown. In view of these general principles, the systems and methods described herein are configured to implement such cognitive interference effects in quantum circuits so that they can be run on gate-based quantum computers.

As described herein, trapped atomic ions is an example of quantum information processing approach that has delivered fully programmable machines. In trapped ion QIP, interactions may be naturally realized as extensions of common two-qubit gate interactions. Therefore, it is desirable to use entangling gates for efficient (e.g., reduced gate count) quantum circuit constructions to implement interactions in trapped ion technology. One particular interaction available in the use of trapped ions for quantum computing is the so-called Mølmer-Sørensen (MS) gate, also known as the XX coupling or Ising gate. To achieve computational universality, the Mølmer-Sørensen gate (either locally addressable or globally addressable) is complemented by arbitrary single-qubit operations, for example.

Using these principles, the exemplary system and method described herein provides for a configuration of a quantum circuit that has a plurality of qubits that model cognitive interference effects. In particular, the system and method includes applying a laser to an ion trap, which includes a plurality of qubits, to set a probability of a single event by rotating at least one qubit of the plurality of qubits to fix a relative angle of the at least one qubit. Moreover, the quantum circuit is configured by connecting a plurality of events, including the single event, such that an outcome of the single event dictates an output of a subsequent event of the plurality of events to be more or less likely to occur. Furthermore, the respective plurality of events are then entangled such that a plurality of states representing different potential events interfere with one another, including an interference between incompatible outcomes of at least two of the plurality of events. By doing so, the quantum circuit can be configured to measures the respective outcomes of the plurality of events to model a result when the quantum computer determines an outcome of at least one event of the plurality of events, such that possible outcomes of other events of the plurality of events are removed.

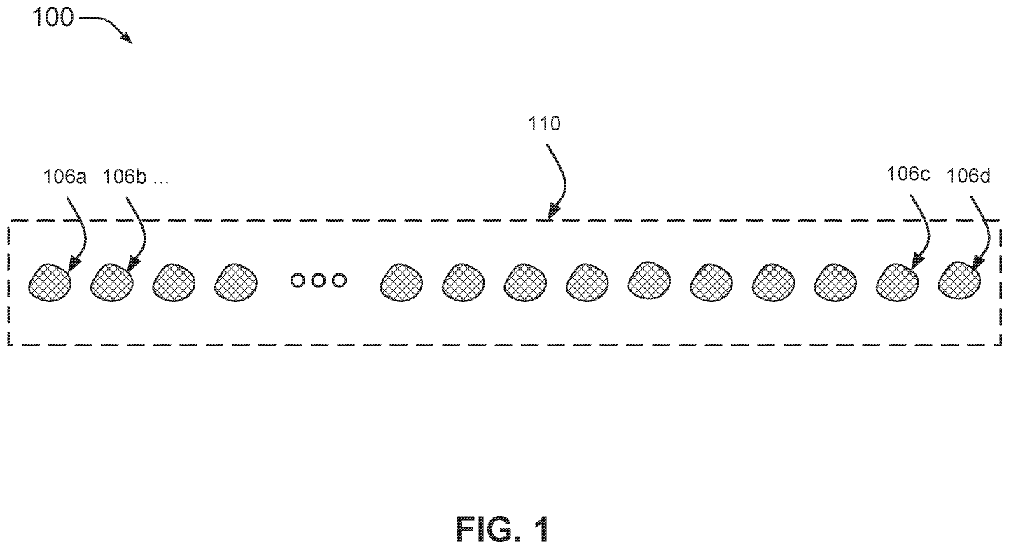

As will be described in detail below, FIGS. 1-3 provide a general description of an exemplary QIP system or quantum computer, and more specifically, of atomic-based QIP systems or quantum computers, that can be configured to perform the exemplary algorithms and methods described herein.

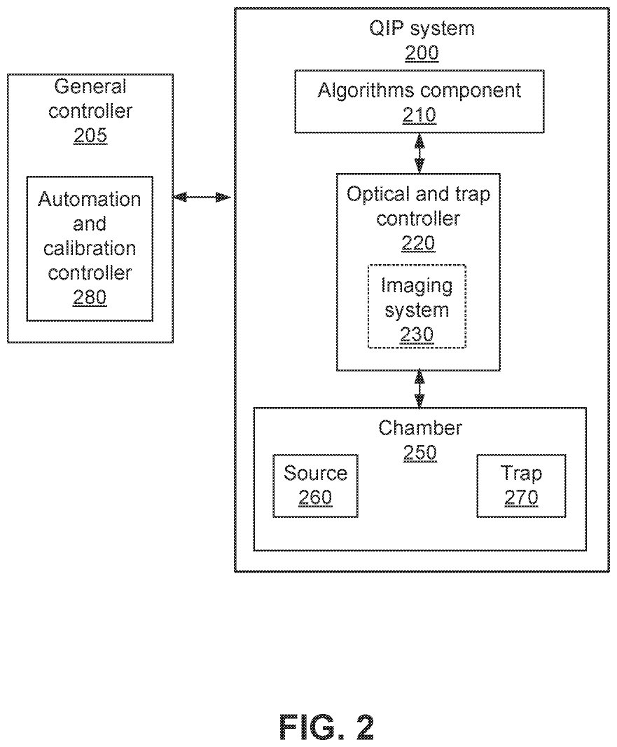

In particular, FIG. 1 illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions (e.g., a plurality of ions) into the chain 110 that are laser-cooled to be nearly at rest. The number of atomic ions (N) trapped can be configurable and more or fewer atomic ions may be trapped. The atomic ions can be Ytterbium ions (e.g., ¹⁷¹Yb⁺ ions), for example. The atomic ions are illuminated with laser (optical) radiation tuned to a resonance in ¹⁷¹Yb⁺ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

As will be described in detail below, and according to an exemplary aspect, the ions in the ion trap can be configured by applying a laser (e.g., a Raman configuration) to one or more of the plurality of qubits to set a probability of a single event by rotating the one or more qubits to fix a relative angle of the at least one qubit. These details will be described below.

FIG. 2 is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200, including the methods and algorithms described herein. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations.

In an exemplary aspect, the algorithms component 210 can be configured to break down code for quantum computations or quantum simulations into computing or gate primitives that can be physically implemented. As such, the algorithms component 210 may provide instructions to various components of the QIP system 200 (e.g., to the optical and trap controller 220) to enable the implementation of quantum circuits, or their equivalents, such as the ones described herein. That is, the algorithms component 210 can be configured to map different computing primitives into physical representations using, for example, the ion chains in the ion trap 270. Thus, the algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems (e.g., optical sources) can be at least partially located in the optical and trap controller 220 and/or in the chamber 250. For example, optical systems within the chamber 250 may refer to optical components or optical assemblies. The optical and trap controller 220 can be configured to generate one or more lasers to rotate the ions and set a probability of the respective events associate with each qubit. For example, optical sources of the optical and trap controller 220 can be configured to ionization of the atomic species, control (e.g., phase control) of the atomic ions, and for fluorescence of the atomic ions that can be monitored and tracked by image processing algorithms operating in an imaging system 230, for example.

More particularly, the QIP system 200 can include an imaging system 230 that may comprise a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210. These and/or components of the QIP system 200 may be used in connection with the techniques for generating and/or configuring a quantum circuit that accurately models scenarios in cognitive science that are known to violate assumptions from classical probability.

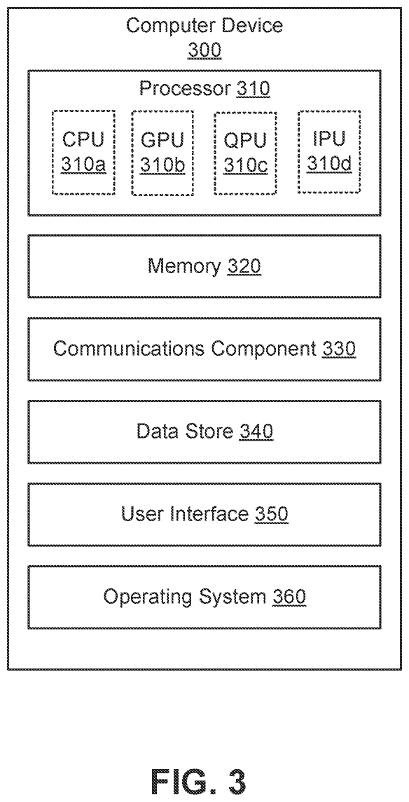

FIG. 3 illustrates is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, and with further details provided below, the present disclosure provides various aspects of techniques for quantum circuit design and configuration that accurately models scenarios in cognitive science that are known to violate assumptions from classical probability. As described in detail below, the system and method of an exemplary aspect designs/configures a quantum circuit that models known “interference effects” between mutually exclusive events whose outcome is not yet known, in such a way that an event that depends on these events is judged to be more or less likely than the classical law of total probability would allow.

In an exemplary aspect, the circuit design has four components: (1) a configuration to “set” the probability of a particular event (e.g., by rotating a coordinate frame to fix an angle between two pairs of axes), (2) a configuration to connect events saying that the outcome of a particular event may make an output of a subsequent event more or less likely, (3) a configuration to “entangle” events so that states representing different potential events can interfere with one another, including interference between incompatible outcomes, and (4) a configuration that “measures” events to model what happens when the system learns the outcome of one of the hitherto unknown events and to remove the possibility of other outcomes. The combination of such components according to the disclosed system and method accurately models disjunction interference effects from cognitive science.

In general, it should be appreciated that human judgements and choices can often defy rules they would be expected to follow if the processes followed the rules of classical probability. For example, the order in which questions are asked matters in ways that violate the classical notion that a conjunction is modeled by an intersection of fixed sets. Currently, order effects (i.e., the variation in the order in which questions are asked) can be accounted for using quantum probability as an alternative to classical probability. Quantum probability depends on comparing angles rather than volumes, and importantly, measuring a system causes it to “collapse” from a superposition of states, where the state is projected onto whichever pure state is observed, with a probability determined by the magnitude-squared of the projection output. Because projections do not commute with one another, the order of projections matters so the probability of different outcomes depends on the order of measurement.

According to an exemplary aspect, the system and method described herein is configured to create a quantum circuit for each question with a single qubit and a single gate that are configured to model one event (e.g., a single event) with two outcomes (e.g., A and not A=˜A), where a qubit in the quantum circuit is assigned to that event. Moreover, the system and method are configured to apply a single-qubit rotation to set the appropriate output probability. In other words, particular rotations and ranges can be defined by the quantum system (e.g., as described above for FIGS. 2 and 3 by applying lasers to the respective ions in the ion trap) for an angle θ defined the amount of X-rotation. In this aspect, an angle θ defines the probability of the particular event.

Thus, the systems and methods described herein are configured to implement a quantum circuit for addressing cognitive interference and can be executed on a gate-based quantum computer in an exemplary aspect. For example, a native gate set is a set of quantum gates that can be physically executed on hardware computing systems (e.g., FIGS. 2-3) by addressing ions (e.g., the exemplary ion chain in FIG. 1) with resonant lasers via stimulated Raman transitions. The angle θ can be defined by the amount of X-rotation where single-qubit gates can be rotated along different axes on a Bloch sphere and/or as rotations along a fixed axis while rotating the Bloch sphere itself. In an exemplary aspect, the rotations can be physically implemented as Rabi oscillations that are made with a two-photon Raman transition to drive the plurality of qubits, such as the ion chain shown in FIG. 1, for example, on resonance using a pair of lasers in a Raman configuration that can be implemented by the optical and trap controller 220, for example. Moreover, the ranges can be controlled by varying the duration of the laser pulses of the Raman configuration.

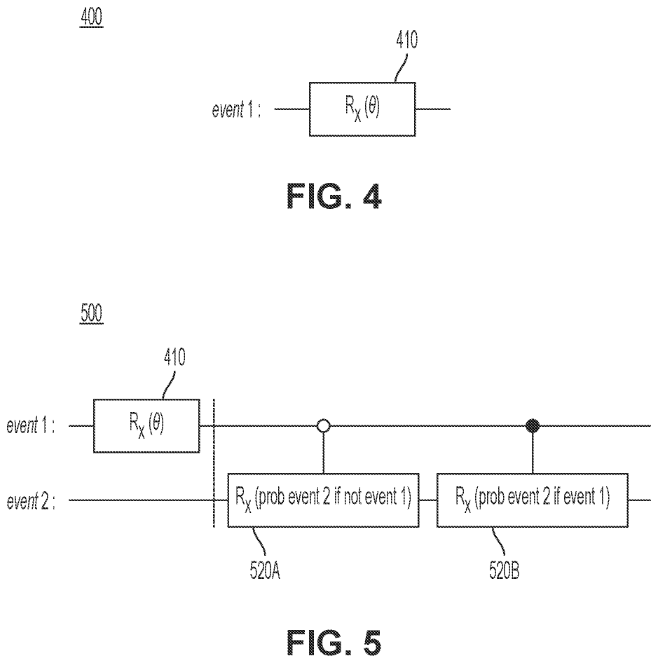

FIG. 4 illustrates an exemplary quantum circuit 400 including an X-rotation applied to set an output probability in accordance with aspects of this disclosure. According to an exemplary aspect, the event (e.g., event 1) can be represented by a qubit and gate 410 of the quantum circuit where the qubit is rotated at a certain angle to define the probably of the single event. In particular, the event in FIG. 4 illustrates an X-rotation, where the angle θ is defined as follows according to Equation (1):

cos²(θ)=P(A)⇒θ=arccos \sqrt{P(A)}

According to this configuration, the system and method is configured to determine the appropriate angles θ to model each the probabilities of each question separately. In an aspect, this probably can be based on preloaded data in the data store as described above, for example. In addition, quantum computing uses complex coordinates, which adds a critical dimension. In an exemplary aspect, instead of being predicted by a single angle θ, each question vector preferably has a phase angle φ, and an appropriate combination of rotations can be used to generate any of these states.

In an exemplary aspect, for expected probability for question vectors C and G (which can be exemplary events of a plurality of events), for example, in addition to fitting the θ_{C} and θ_{G} parameters to give the expected probabilities for C and G question vectors on their own, the system and method can be configured to determine a parameter that fits the expected probability of transitioning from G to C based on the phase angle φ.

In view of the foregoing, the exemplary system and method can further be configured to design and configure a quantum cognitive model of disjunction effects for a quantum computer, such as the quantum computer and system described above with respect to FIGS. 2 and 3. More particularly, the exemplary system and method can be configured to design a quantum computer circuit having four components: (1) a configuration to “set” the probability of a particular (i.e., a “single”) event (e.g., by rotating a coordinate frame to fix an angle between two pairs of axes, (2) a configuration to connect events saying that the outcome of the particular event makes an output of a subsequent event more or less likely, (3) a configuration to “entangle” events so that states representing different potential events can interfere with one another, including interference between incompatible outcomes, and (4) a configuration that “measures” events to model what happens when the system learns the outcome of one of the hitherto unknown events and to remove the possibility of other outcomes. The combination of such components that are implemented by a quantum circuit by the disclosed system and method accurately models disjunction interference effects from cognitive science as described above.

In an exemplary aspect, the quantum circuit can be designed to be a combination of basic circuit elements that implement these four key processes. It is also noted that the process for setting the probability of a particular (i.e., a “single”) event is described above in FIG. 4, for example, by applying a single-qubit rotation (e.g., gate 410) to set the appropriate output probability.

In an exemplary aspect, the system (e.g., the general controller 205 as shown in FIG. 2) is configured to implement the conditional probability P(B|A) by setting A and adding a 2-qubit gate that implements a partial rotation on the qubit representing event B conditioned on the qubit for A. It should be appreciated that events A and B can correspond to question vectors C and G, of the example described above.

FIG. 5 illustrates an implementation of a quantum circuit 500 comprising basic combination of changing the probability of second event based on an occurrence of a first event in accordance with aspects of this disclosure. Moreover, the first (or single event 1) is represented by gate 410. The 2-qubit gate is represented by gates 520A and 520B, which is implemented for a basic combination of changing the probability of event B (e.g., event 2) based on whether event A (e.g., event 1) does not happen (e.g., gate 520A) or happens (e.g., gate 520B).

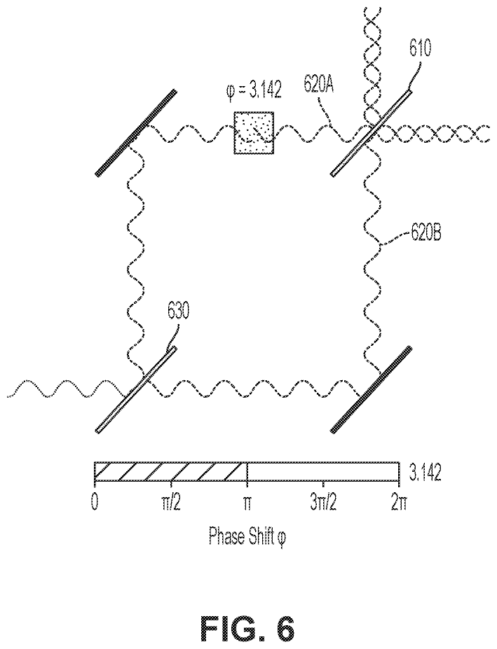

FIG. 6 illustrates a classical Bayesian network connecting two events in accordance with aspects of this disclosure. That is, the two components described above with respect to FIG. 5, for example, are sufficient to implement circuits that are equivalent to a classical Bayesian network connecting events 1 and 2. The classical Bayesian network can be implemented as part of imaging system 230 described above according to an exemplary aspect. Moreover, it should also be appreciated that this circuit obeys the classical law of total probability, in this case the rule that P(B)=P(B|A)P(A)+P(B|A′)P(A′). Thus, the quantum circuit components of the exemplary aspect are configured to provide the same outcomes as their classical counterparts.

However, the exemplary system and method can further be configured to design and configure a quantum circuit that implements interference between unknown outcomes and can be based on the intuition behind a Mach-Zehnder Interferometer, as shown in FIG. 6, as described above. In such a system, a half-mirror 610 splits a beam into two parts 620A and 620B, where one of those parts (e.g., 620A) is configured to undergo a phase shift (e.g., φ=3.142), and when the beams are brought back together (e.g., 630), they interfere constructively or destructively based on the phase angle.

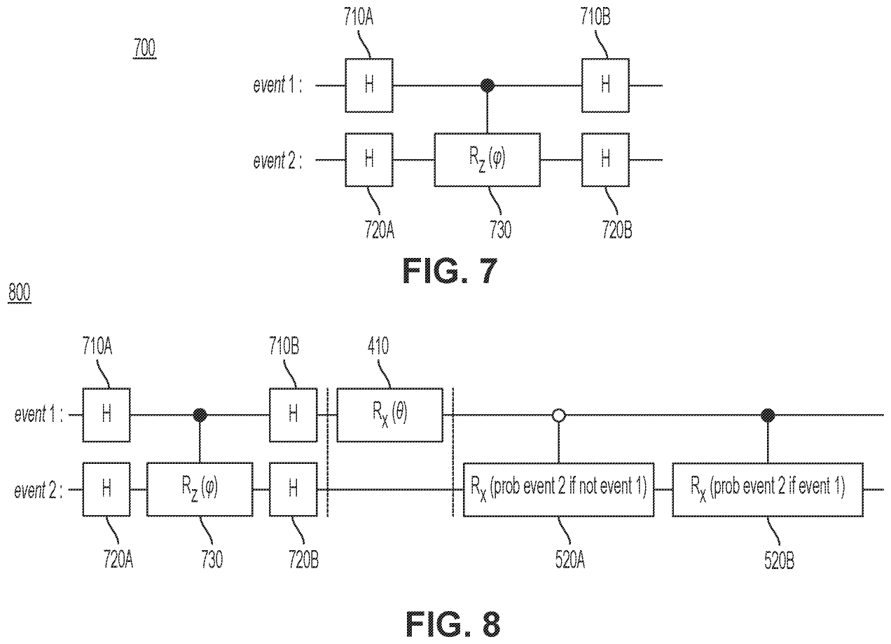

Thus, in the exemplary aspect, the quantum circuit can be configured to behave in the same way as shown in FIG. 7, which illustrates a quantum circuit 700 in accordance with aspects of this disclosure. In particular, the qubit for event 1 is configured according to Hadamard gates 710A and 710B and the qubit for event 2 is configured according to Hadamard gates 720A and 720B, with a gate 730 configured to apply the phase shift φ therebetween. In this regard, it is noted that this configuration is not the only option, for example, and just putting the gates H→R_{z}(ϕ)→H on the same qubit will demonstrate interference between the two states in a single qubit. However, by using 2-qubit configurations to generate interference (e.g., the two qubits represent events 1 and 2, respectively), the system and method is configured model the circuit to implement an intuition like “the uncertainty in event 1 affects the phase change in event 2”.

FIG. 8 illustrates a quantum circuit configured as a conditional probability with interference circuit in accordance with aspects of this disclosure. It should be appreciated that the quantum computing system (e.g., as described in FIGS. 2 and 3) is configured to generate a quantum circuit design combining the configurations described above with respect to FIGS. 4, 5 and 7, of which the configured design is shown in FIG. 8. As a result, the system and method provided here configure the quantum circuit to connect the plurality of events, including the single event (e.g., event 2), such that an outcome of the single event (e.g., event 2) dictates an output of a subsequent event (e.g., event 1) of the plurality of events to be more or less likely to occur. According to the resulting circuit 800 shown in FIG. 8, the quantum circuit is configured to entangle the respective plurality of events such that a plurality of states representing different potential events interfere with one another, including an interference between incompatible outcomes (i.e., 520A and 520B) of at least two of the plurality of events. As such, the system and method effectively designs a quantum circuit into the following “conditional probability with interference” circuit

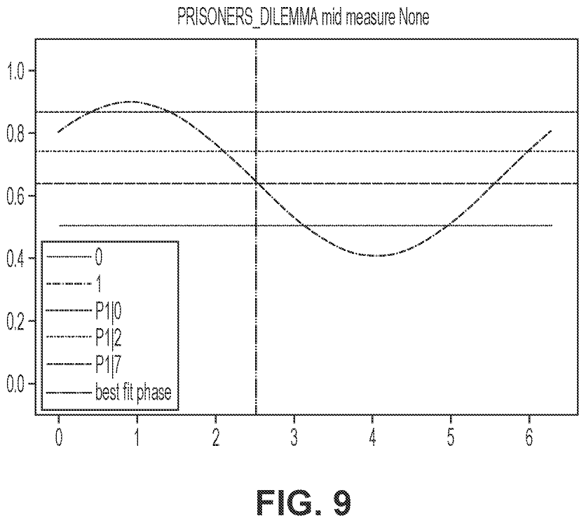

In an exemplary aspect, FIG. 9 illustrates how the circuit of FIG. 8 is configured to behave with the numbers filled in from an example of a “Prisoner's Dilemma” problem. In general, the Prisoner's Dilemma is a known paradox, in which there are two prisoners with no means of communication, whom the police have reason to believe may be connected to the same crime. Each prisoner is offered two choices: (1) “Betray” and attest that the other prisoner is a partner in crime, or (2) “Cooperate” by not implicating the other prisoner in the crime. If both prisoners cooperate, they both go to jail for 2 years, whereas if one cooperates and the other betrays, then the betrayer only goes to jail for 1 year, and the cooperator for 5 years. Finally, if both betray one another, then both prisoners go to jail for 3 years. As illustrated in FIG. 9, event 1 is the partner's decision result, with state |0 [symbol] corresponding to “Betray” and state |1 [symbol] corresponding to “Cooperate”. Event 2 is the subject's decision, with the same correspondences.

The angles represent the average probabilities with the probability of event 1 itself, a value of 50% is commonly used, reflecting the fact that the subjects are not given any prior estimate of this event. According to the exemplary aspect, it is understood that the probability of event 2 occurring varies with the phase angle φ as described above. As a result, the system and method are configured to determine a value of φ for which the estimated probability is the same as that observed in experiments. The quantum circuit 800 can be designed to reflect this identified phase angle φ in an exemplary aspect based on collected data from experiments, for example.

As further described above, the three components assembled can generate the expected probability of event 2 if the outcome of event 1 is unknown. That is, the quantum circuit can be designed for the expected probability based on the: (1) configuration to “set” the probability of a particular (i.e. a “single”) event (e.g., by rotating a coordinate frame to fix an angle between two pairs of axes, (2) the configuration to connect events saying that the outcome of the particular event makes an output of a subsequent event more or less likely, and (3) the configuration to “entangle” events so that states representing different potential events can interfere with one another, including interference between incompatible outcomes.

However, when the outcome of event 1 (such as partner betrays/cooperates) becomes known, this corresponds for the quantum circuit to measuring the qubit representing event 1, at which point it collapses to the pure |0 [symbol] or |1 [symbol] state. As described above, this configuration can be modeled without mid-circuit measurement using swap gates and ancilla qubits.

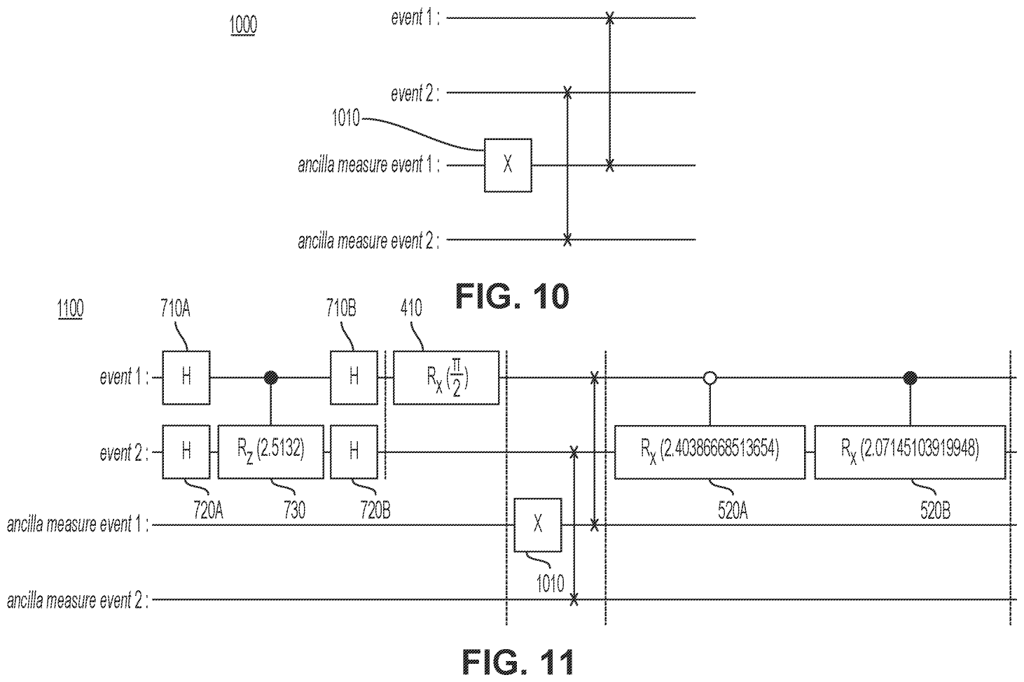

FIG. 10 illustrates a quantum circuit 1000 having a configuration modeled without mid-circuit measurement using swap gates and ancilla qubits in accordance with aspects of this disclosure. As shown, the system and method can be configured to design a circuit with X rotation (e.g., gate 1010) on the “ancilla measure event 1” qubit that can be used to simulate measuring a |1 [symbol] rather than a |0 [symbol] for the first event. It is noted that swapping in a |0 [symbol] qubit for event 2 corresponds just to resetting this qubit.

This component is added in between the interference component and the conditional probability component discussed above, to generate the final circuit for this paradox in FIG. 11, which illustrates a quantum circuit in accordance with aspects of this disclosure. That is, quantum circuit 1100 is configured as a combination of the sub-circuits described above with respect to FIGS. 4, 5, 7 and 10. In this aspect, quantum circuit 1100 is configured to measure the respective outcomes of the plurality of events to model a result when the quantum computer determines an outcome of at least one event (e.g., event 2) of the plurality of events, such that possible outcomes of other events (e.g., event 1) of the plurality of events are removed. Moreover, using the configurations and systems described above with respect to FIGS. 2 and 3, the system and method can be configured to implement a plurality of quantum operations using the quantum circuit 1100, for example, which is configured to measures the respective outcomes of the plurality of events.

Thus, according to the example of FIG. 9, the quantum circuit 1100 can be configured to recreate all the desired outcomes for the Prisoner's Dilemma problem. It is noted that the same circuit structure with different parameter values can recreate other well-known disjunction problems. By designing a quantum circuit with the four circuit components as described herein, the resulting quantum circuit can accurately model disjunction interference effects from cognitive science in an exemplary aspect. Moreover, it is further noted that FIG. 11 illustrates an exemplary circuit for disjunction effects that can be run in a regular duty cycle of an 11 qubit machine, such as the exemplary quantum computing machines and systems described above with respect to FIGS. 2 and 3.

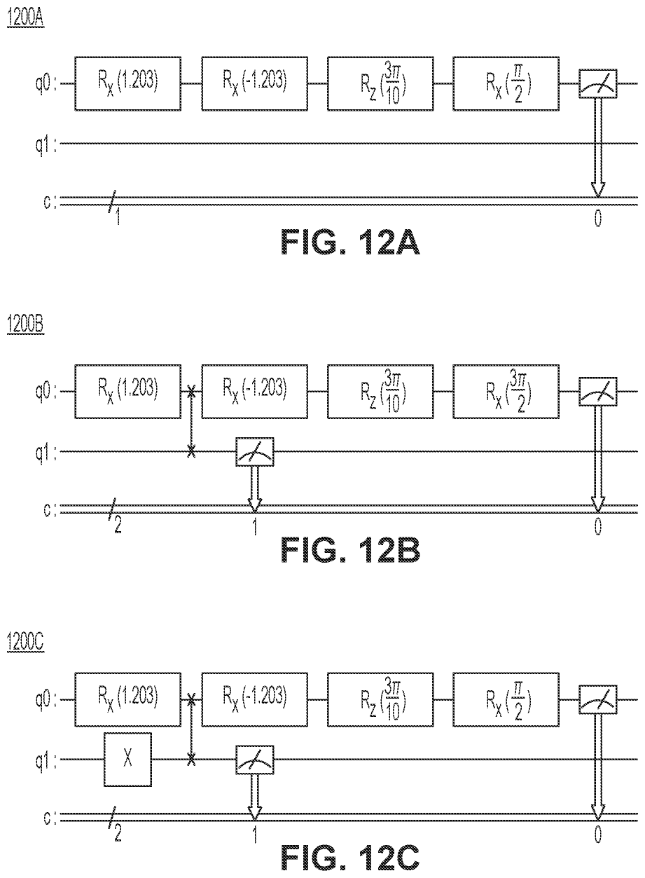

It is also noted that in an exemplary aspect, all of the circuits can use four qubits or fewer. In particular, FIGS. 12A-12C illustrate quantum circuits configured to process question vectors order effects in accordance with aspects of this disclosure. More particularly, FIGS. 12A-12C illustrate exemplary quantum circuits 1200A, 1200B and 1200C configured to process question vectors C and G for order effects. In these exemplary circuits, FIG. 12A represents a quantum circuit 1200A including a sequence of question vector G and then question vector C rotations without mid-measurement. FIG. 12B represents a quantum circuit 1200N including a sequence of question vector G and then question vector C rotations with mid-measurement of |0 [symbol] . FIG. 12C represents a quantum circuit 1200C including a sequence of question vector G and then question vector C rotations with mid-measurement of or |1 [symbol] . Thus, it should be appreciated that the designed quantum circuits 1200A-1200C can be adjusted to have the three exemplary variations as shown in FIGS. 12A-12C, but also that other configurations are possible.

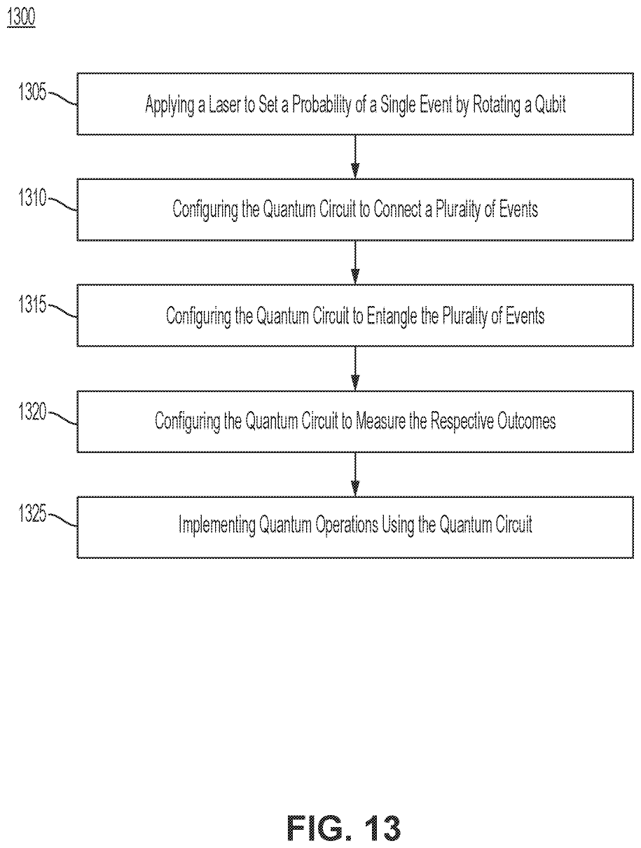

FIG. 13 illustrates a method for configuring a quantum circuit having a plurality of qubits that model cognitive interference effects in accordance with aspects of this disclosure. It general, it is noted that the exemplary method 1300 can be implemented using the components and systems described herein, especially with respect to QIP system 200 and general controller 205 of FIG. 2 as described above.

As shown, initially at step 1305, the method includes applying a laser to an ion trap that including a plurality of ions (e.g., a trapped ion chain) to set a probability of a single event by rotating at least one qubit of the plurality of qubits to fix a relative angle of the at least one qubit. This step can be performed by the optical sources of the optical and trap controller 220, for example.

Next, the general controller 205 controls QIP system 200 to configuration the particular quantum circuit to model cognitive interference effects. In particular, at step 1310, the method includes configuring the quantum circuit to connect a plurality of events, including the single event, such that an outcome of the single event dictates an output of a subsequent event of the plurality of events to be more or less likely to occur. An example of the connected events is shown in FIG. 11 in which event 2 will dictate the output of event 1.

At step 1315, the method further includes configuring the quantum circuit to entangle the respective plurality of events such that a plurality of states representing different potential events interfere with one another, including an interference between incompatible outcomes of at least two of the plurality of events. This entanglement is represented in FIG. 11 by the vertical connected lines between the events 1 and 2 and the ancilla measure events 1 and 2, in accordance with an exemplary aspect. At step 1320, the quantum circuit is then configured to measure the respective outcomes of the plurality of events to model a result when the quantum computer determines an outcome of at least one event of the plurality of events, such that possible outcomes of other events of the plurality of events are removed.

Finally, the method includes step 1325, which may be implemented by algorithms component 210, for example, of the QIP system 200. As shown, this step includes implementing a plurality of quantum operations using the quantum circuit that is configured to measures the respective outcomes of the plurality of events. As a result, the exemplary method configures a physical quantum circuit that accurately models scenarios in cognitive science that are known to violate assumptions from classical probability.

In general, it is noted that the foregoing description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed:

1. A method for configuring a quantum circuit having a plurality of qubits that model cognitive interference effects, the method comprising:
applying a laser to an ion trap including a plurality of ions to set a probability of a single event by rotating at least one qubit of the plurality of qubits to fix a relative angle of the at least one qubit;
configuring the quantum circuit to connect a plurality of events, including the single event, such that an outcome of the single event dictates an output of a subsequent event of the plurality of events to be more or less likely to occur;
configuring the quantum circuit to entangle the respective plurality of events such that a plurality of states representing different potential events interfere with one another, including an interference between incompatible outcomes of at least two of the plurality of events; and
configuring the quantum circuit to measures the respective outcomes of the plurality of events to model a result when the quantum computer determines an outcome of at least one event of the plurality of events, such that possible outcomes of other events of the plurality of events are removed.

2. The method according to claim 1, wherein the relative angle of the at least one qubit is rotated between two pairs of axes.

3. The method according to claim 1, further comprising measuring the respective outcomes of the plurality of events to model a scenario in cognitive science that violates assumptions from a classical probability.

4. The method according to claim 1, further comprising configuring the quantum circuit such that each even of the plurality of events comprises a single qubit and a single gate that models two possible outcomes indicated by a qubit state of the respective event.

5. The method according to claim 1, wherein the applying of the laser comprises applying a laser in a Raman configuration to rotate the at least one qubit.

6. The method according to claim 5, wherein the applying of the laser to rotate the at least one qubit comprises generating Rabi oscillations by a two-photon Raman transition of the Raman configuration to drive the at least one qubit.

7. The method according to claim 6, further comprising controlling a range of a respective rotation of the at least one qubit by varying a duration of laser pulses of the Raman configuration.

8. The method according to claim 1, further comprising configuring the quantum circuit to entangle the respective plurality of events by implementing a conditional probability of the single event.

9. The method according to claim 8, further comprising adding a two-qubit gate to implement a partial rotation on an additional qubit of the plurality of qubits that represents an additional event conditioned on the at least one qubit associated with the single event.

10. The method according to claim 1, further comprising implementing a plurality of quantum operations using the quantum circuit that is configured to measures the respective outcomes of the plurality of events.

11. A system for configuring a quantum circuit having a plurality of qubits that model cognitive interference effects, the system comprising:
an ion trap configured to trap a plurality of ions;
an optical and trap controller configured to apply a laser to the ion trap to set a probability of a single event by rotating at least one qubit of the plurality of qubits to fix a relative angle of the at least one qubit; and
a controller configured to:
configure the quantum circuit to connect a plurality of events, including the single event, such that an outcome of the single event dictates an output of a subsequent event of the plurality of events to be more or less likely to occur,
configure the quantum circuit to entangle the respective plurality of events such that a plurality of states representing different potential events interfere with one another, including an interference between incompatible outcomes of at least two of the plurality of events, and
configure the quantum circuit to measures the respective outcomes of the plurality of events to model a result when the quantum computer determines an outcome of at least one event of the plurality of events, such that possible outcomes of other events of the plurality of events are removed.

12. The system according to claim 11, wherein the relative angle of the at least one qubit is rotated between two pairs of axes.

13. The system according to claim 11, wherein the controller includes an algorithms component configured to measure the respective outcomes of the plurality of events to model a scenario in cognitive science that violates assumptions from a classical probability.

14. The system according to claim 11, wherein the controller is further configured to configure the quantum circuit such that each even of the plurality of events comprises a single qubit and a single gate that models two possible outcomes indicated by a qubit state of the respective event.

15. The system according to claim 11, wherein the optical and trap controller is further configured to apply of the laser comprises applying a laser in a Raman configuration to rotate the at least one qubit.

16. The system according to claim 15, wherein the optical and trap controller is further configured to apply the laser to rotate the at least one qubit by generating Rabi oscillations by a two-photon Raman transition of the Raman configuration to drive the at least one qubit.

17. The system according to claim 16, wherein the controller is further configured to control a range of a respective rotation of the at least one qubit by varying a duration of laser pulses of the Raman configuration.

18. The system according to claim 11, wherein the controller is further configured to configure the quantum circuit to entangle the respective plurality of events by implementing a conditional probability of the single event.

19. The system according to claim 18, wherein the controller includes an algorithms component configured add a two-qubit gate to implement a partial rotation on an additional qubit of the plurality of qubits that represents an additional event conditioned on the at least one qubit associated with the single event.

20. The system according to claim 11, wherein the controller includes an algorithms component configured to implement a plurality of quantum operations using the quantum circuit that is configured to measures the respective outcomes of the plurality of events.
